(19) United States
(12) Patent Application Publication
(10) Pub. No.: US 2026/0039489 A1
(43) Pub. Date: Feb. 5, 2026

(54) CONFIGURING A PORTABLE TRAFFIC MARKER TO BE A NODE IN A BLOCKCHAIN

(71) Applicant: Toyota Motor Engineering & Manufacturing North America, Inc., Plano, TX (US)

(72) Inventor: Alexander Tuan Pham, San Jose, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/793,130

(22) Filed: Aug. 2, 2024

(51) Int. Cl. H04L 9/00

(52) U.S. Cl. CPC H04L 9/50; H04L 2209/84

(57) ABSTRACT

A system for configuring a portable traffic marker to be a node in a blockchain can include an attachment mechanism, an electrical power source, a communications device, a processor, and a memory. The attachment mechanism can be configured to attach the system to the portable traffic marker. The electrical power source can be configured to provide power to the system. The memory can store a blockchain node module and a communications module. The blockchain node module can include instructions that, when executed by the processor, cause the processor to perform operations of the node in the blockchain. The communications module can include instructions that, when executed by the processor, cause the processor to communicate, via the communications device, with another node in the blockchain.

### TECHNICAL FIELD

The disclosed technologies are directed to configuring a portable traffic marker to be a node in a blockchain.

### BACKGROUND

A portable traffic marker can be an object placed on a road to temporarily redirect traffic in a safe manner. For example, at a specific location, one or more portable traffic markers can be placed on the road in an arrangement that produces a separation of the traffic into lanes or a merger of multiple lanes into a single lane. A portable traffic marker can have a specific design, color scheme, or both. Sometimes, the specific design or color scheme can be prescribed by a regulatory agency. Different types of portable traffic markers can include, for example, a traffic cone, a construction barrel, a traffic barricade, a waffle-board barricade, a parade barricade, a Jersey barrier, a delineator, a vertical traffic panel, or the like. Usually, a presence of a portable traffic marker at a specific location can be indicative of a safety concern at the specific location.

### SUMMARY

In an embodiment, a system for configuring a portable traffic marker to be a node in a blockchain can include an attachment mechanism, an electrical power source, a communications device, a processor, and a memory. The attachment mechanism can be configured to attach the system to the portable traffic marker. The electrical power source can be configured to provide power to the system. The memory can store a blockchain node module and a communications module. The blockchain node module can include instructions that, when executed by the processor, cause the processor to perform operations of the node in the blockchain. The communications module can include instructions that, when executed by the processor, cause the processor to communicate, via the communications device, with another node in the blockchain.

In another embodiment, a blockchain can include a first portable traffic marker and a second portable traffic marker. The first portable traffic marker can have a first electrical power source, a first communications device, a first processor, and a first memory, and can be configured to perform operations of a first node in the blockchain. The second portable traffic marker can have a second electrical power source, a second communications device, a second processor, and a second memory, and can be configured to perform operations of a second node in the blockchain.

In another embodiment, a blockchain can include a portable traffic marker and a vehicle. The portable traffic marker can have a first electrical power source, a first communications device, a first processor, and a first memory, and can be configured to perform operations of a first node in the blockchain. The vehicle can have a second electrical power source, a second communications device, a second processor, and a second memory, and can be configured to perform operations of a second node in the blockchain.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment in which a portable traffic marker, configured to be a node in a blockchain, can be used, according to the disclosed technologies.

FIG. 2 is a block diagram that illustrates an example of a system for configuring a portable traffic marker to be a node in a blockchain, according to the disclosed technologies.

FIG. 3 is a diagram that illustrates examples of portable traffic markers that can be the portable traffic marker configured to be a node in a blockchain, according to the disclosed technologies.

### DETAILED DESCRIPTION

Because a presence of a portable traffic marker at a specific location can be indicative of a safety concern at the specific location, entities engaged in traffic, or management of traffic, can have a desire to have an ability to be able to produce, at the specific location, a record of a situation, particularly a situation that involves a safety concern. Moreover, such a desire can include an ability to verify the record of the situation as a safeguard against an effort to have the record altered.

A blockchain can be a database that can be used to verify a record of data. A blockchain can be a permissioned blockchain or a permissionless blockchain. A permissioned blockchain, also known as a private blockchain, can use an access control to govern access to the permissioned blockchain. A permissionless blockchain, also known as a public blockchain, does not use access controls and can be open to the public.

A blockchain can be organized as a sequence of blocks. A current block, of the blockchain, can include: (1) one or more records of data, received by an electronic ledger system, (2) a hash of a previous block of the blockchain, and (3) a nonce. The hash can be, for example, a cryptographic hash. The nonce can be an arbitrary number used just once in a cryptographic communication. A subsequent block, of the blockchain, can include a hash of the current block. Because the subsequent block can include the hash of the current block, an alteration a record of data in the current block can be determined by reference to the hash included in the subsequent block.

The electronic ledger system can operate the blockchain. The electronic ledger system can include an electronic device or, alternatively, can include several electronic devices disposed in a peer-to-peer network. An electronic ledger system in which several electronic devices are disposed in a peer-to-peer network can be referred to as a distributed ledger system. Each electronic device in a distributed ledger system can be referred to as a node in the blockchain.

In a distributed ledger system, each node can save a copy of the blockchain. The distributed ledger system can cause copies of a prospective block to be communicated to the nodes. Each node that received a copy of the prospective block can perform a verification operation of the copy of the prospective block. Each node that verified a copy of the prospective block can transmit, to the other nodes, a result of the verification operation. Some nodes in the blockchain can be validator nodes. Validator nodes can participate in a consensus operation of the blockchain. The consensus operation can determine a consensus about which copies of the prospective block are correct copies. One of skill in the art of blockchain technology understands that a consensus operation performed by a validator node can include one or more of a proof of work operation, a proof of stake operation, or the like. In response to a result of the consensus operation being that the copy of the prospective block at a specific node is valid, the prospective block can be added to the copy of the blockchain maintained by the specific node. In response to the consensus operation, each node can update its copy of the blockchain. Because a distributed ledger system can use a consensus operation to determine the correct copy of the blockchain, an alteration of a record of data included in a copy of the blockchain stored at a node of the distributed ledger system can be prevented from being deemed to be the correct copy of the record of data. In this manner, a distributed ledger system can be used to verify a record of data.

Unfortunately, operations performed by a distributed ledger system to verify copies of a prospective block, to determine the consensus, and to update copies of the blockchain can consume a substantial amount of time and energy. For example, an average Bitcoin transaction on the Bitcoin.org blockchain consumes about 215 kilowatt-hours of energy.

The disclosed technologies are directed to configuring a portable traffic marker to be a node in a blockchain. Because: (1) a presence of a portable traffic marker at a specific location can be indicative of a safety concern at the specific location, (2) entities engaged in traffic, or management of traffic, can have a desire to have an ability to be able to produce, at the specific location, a record of a situation, particularly a situation that involves a safety concern, (3) such a desire can include an ability to verify the record of the situation as a safeguard against an effort to have the record altered, and (4) a blockchain can be a database that can be used to verify a record of data, configuring a portable traffic marker to be a node in a blockchain can allow a verifiable record of a situation to be produced at a specific location of the situation.

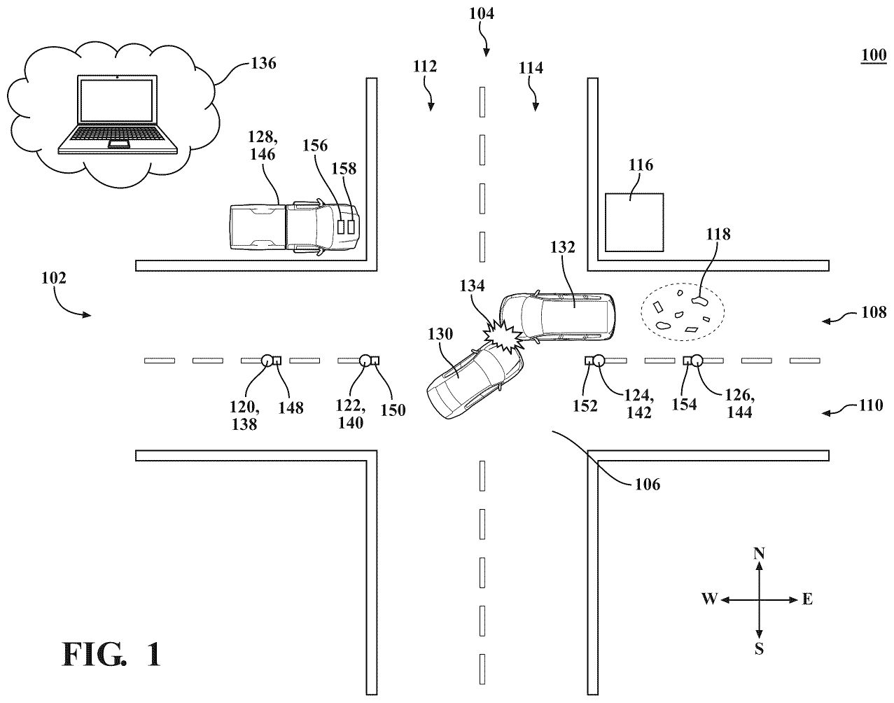

FIG. 1 includes a diagram that illustrates an example of an environment 100 in which a portable traffic marker, configured to be a node in a blockchain, can be used, according to the disclosed technologies. For example, the environment 100 can include a first road 102 (disposed along a line of latitude) and a second road 104 (disposed along a line of longitude). For example, the environment 100 can include a road junction 106 (e.g., an intersection) of the first road 102 and the second road 104. For example, the first road 102 can include a westbound lane 108 and an eastbound lane 110. For example, the second road 104 can include a southbound lane 112 and a northbound lane 114.

For example, the environment 100 can include a roadside unit 116 located at a northeast corner of the road junction 106.

For example, the environment 100 can include debris 118 that exists on a surface of the westbound lane 108 east of the road junction 106.

For example, the environment 100 can include a first portable traffic marker 120, a second portable traffic marker 122, a third portable traffic marker 124, and a fourth portable traffic marker 126. For example, the second portable traffic marker 122 can be located between the westbound lane 108 and the eastbound lane 110 at a western edge of the road junction 106. For example, the first portable traffic marker 120 can be located between the westbound lane 108 and the eastbound lane 110 about fifteen feet west of the second portable traffic marker 122. For example, the third portable traffic marker 124 can be located between the westbound lane 108 and the eastbound lane 110 at an eastern edge of the road junction 106. For example, the fourth portable traffic marker 126 can be located between the westbound lane 108 and the eastbound lane 110 about fifteen feet east of the third portable traffic marker 124.

For example, the environment 100 can include a first vehicle 128, a second vehicle 130, and a third vehicle 132. For example, the first vehicle 128 can be located offroad just northwest of the road junction 106, parked, and facing cast. For example, the second vehicle 130 can be located in the road junction 106 in a process of making a left turn from the eastbound lane 110 to the northbound lane 114. For example, the third vehicle 132 can be located in the road junction 106 in the westbound lane 108. For example, a traffic collision 134 can have occurred between the second vehicle 130 and the third vehicle 132.

For example, the environment 100 can include a cloud computing platform 136.

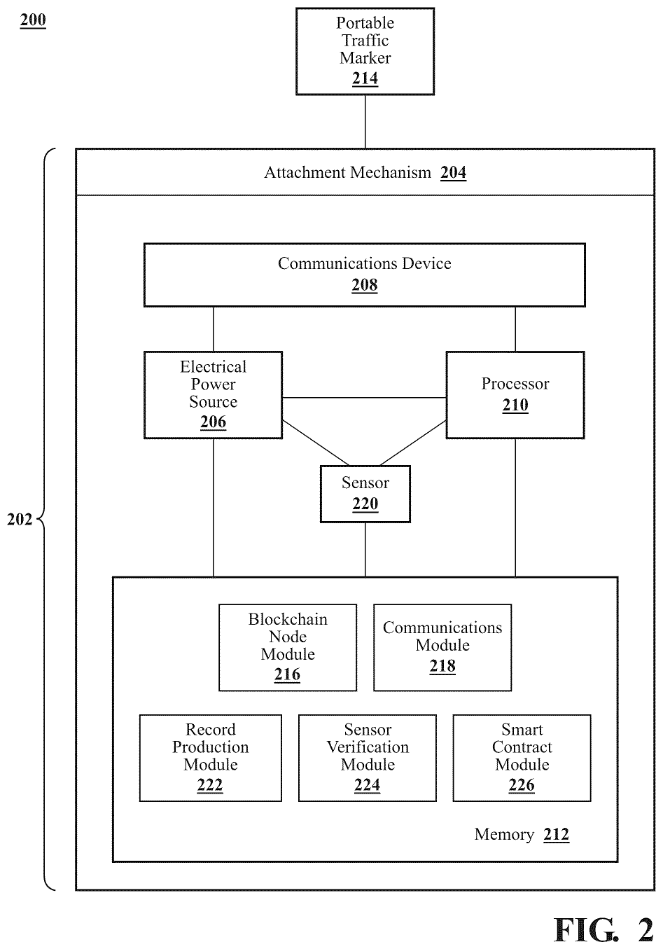

FIG. 2 is a block diagram 200 that illustrates an example of a system 202 for configuring a portable traffic marker to be a node in a blockchain, according to the disclosed technologies. The system 202 can include, for example, an attachment mechanism 204, an electrical power source 206, a communications device 208, a processor 210, and a memory 212. The attachment mechanism 204 can be configured to attach the system 202 to a portable traffic marker 214. The electrical power source 206 can be configured to provide power to the system 202. The electrical power source 208 can be coupled to the communications device 208, the processor 210, and the memory 212. The processor 210 can be coupled to the electrical power source 206, the communications device 208, and the memory 212. For example, the memory 212 can store a blockchain node module 216 and a communications module 218.

For example, the blockchain node module 216 can include instructions that function to control the processor 210 to cause the processor 210 to perform operations of a node in a blockchain.

For example, the communications module 218 can include instructions that function to control the processor 210 to cause the processor 210 to communicate, via the communications device 208, with another node in the blockchain.

For example, the system 202 can be attached to the portable traffic marker 214.

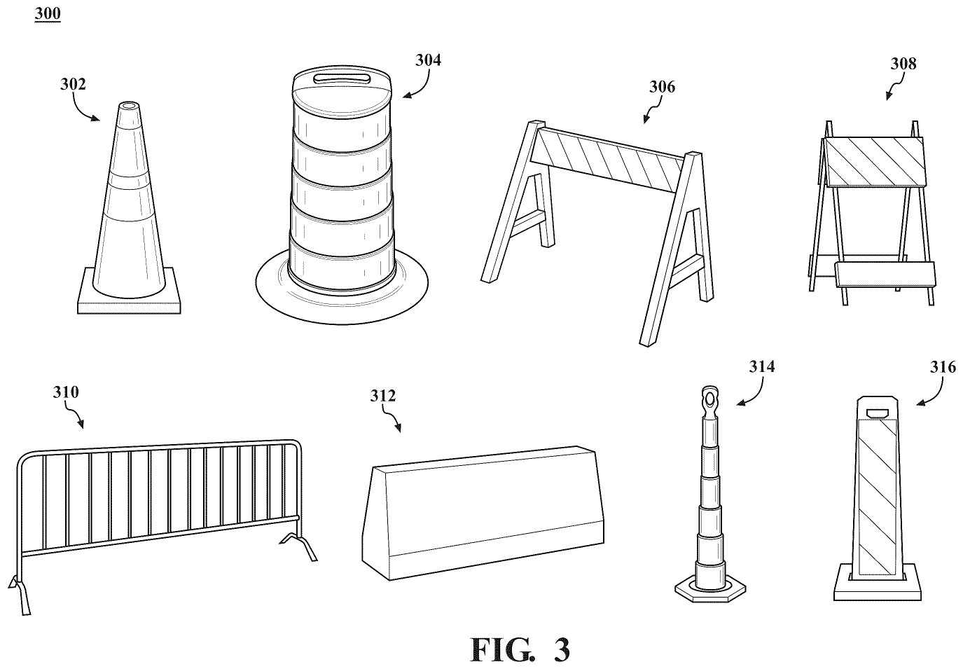

FIG. 3 is a diagram that illustrates examples of portable traffic markers 300 that can be the portable traffic marker 214 configured to be a node in a blockchain, according to the disclosed technologies. For example, portable traffic marker 214 can include one or more of a traffic cone 302, a construction barrel 304, a traffic barricade 306, a waffle-board barricade 308, a parade barricade 310, a Jersey barrier 312, a delineator 314, a vertical traffic panel 316, or the like.

Returning to FIG. 2, for example, the electrical power source 206 can include one or more of a battery, a fuel cell, a capacitor, a supercapacitor, a solar panel, or the like.

For example, the blockchain can be a permissioned blockchain in which the electrical power source 206 can be configured to store an amount of energy and a count of nodes included in the permissioned blockchain can be a function of the amount of energy. In this manner, the permissioned blockchain can control an amount of energy consumed to operate the blockchain.

For example, the nodes (i.e., the portable traffic marker 214 configured to be a node and one or more other nodes) can be registered to the blockchain.

With reference to FIG. 1, for example, the first portable traffic marker 120 can be configured to be a first node 138, the second portable traffic marker 122 can be configured to be a second node 140, the third portable traffic marker 124 can be configured to be a third node 142, and the fourth portable traffic marker 126 can be configured to be a fourth node 144.

Additionally or alternatively, for example, another node can be a vehicle configured to operate as the other node. For example, the vehicle can include an electrical power source, a communications device, a processor, and a memory. For example, the first vehicle 128 can be configured to operate as a fifth node 146. Advantageously, including a vehicle configured to operate as a node in a blockchain can increase an amount of energy available to operate the blockchain.

Additionally or alternatively, for example, another node can be an item of infrastructure (e.g., a street light, a traffic light, a utility pole) configured to operate as the other node. For example, the item of infrastructure can include an electrical power source, a communications device, a processor, and a memory. Advantageously, including an item of infrastructure configured to operate as a node in a blockchain can increase an amount of energy available to operate the blockchain.

For example, the blockchain can include one or more of the first node 138, the second node 140, the third node 142, the fourth node 144, or the fifth node 146. For example, a blockchain can include the second node 140 and the third node 142. Alternatively, for example, a blockchain can include the third node 142 and the fifth node 146. Alternatively, for example, a blockchain can include the second node 140, the third node 142, and the fifth node 146.

Returning to FIG. 2, additionally or alternatively, for example, the system 202 can further include a sensor 220. The sensor 220 can be coupled to the electrical power source 206, the processor 210, and the memory 212. For example, the sensor 220 can include one or more of an imaging sensor, a ranging sensor, a microphone, or the like.

With reference to FIG. 1, for example, the first node 138 can include a microphone 148, the second node 140 can include an imaging sensor 150, the third node 142 can include an imaging sensor 152, the fourth node 144 can include a microphone 154, and the fifth node 146 can further include an imaging sensor 156 and a ranging sensor 158.

Returning to FIG. 2, additionally, for example, the memory 212 can further store a record production module 222. For example, the record production module 222 can include instructions that function to control the processor 210 to cause the processor 210 to produce a record of a situation detected by the sensor 220. For example, the record of the situation can include an image or a sequence of images.

With reference to FIGS. 1 and 2, for example, the system 202 can be configured to produce an image (or a sequence of images) of the situation. For example, the situation can be the traffic collision 134. For example, in an implementation of the system 202 at the second node 140, an image (or a sequence of images) of the traffic collision 134 can be produced by the imaging sensor 150. For example, in an implementation of the system 202 at the third node 142, an image (or a sequence of images) of the traffic collision 134 can be produced by the imaging sensor 152. Additionally, an image (or a sequence of images) of the traffic collision 134 can be produced by the imaging sensor 156 at the fifth node 146.

Additionally, for example, the instructions to produce the record of the situation can include instructions to produce, in response to a receipt of an indication of a likelihood of an existence of the situation, the record of the situation. For example, in order to reduce an amount of energy consumed, the system 202 can be configured to produce the record of the situation in response to the receipt of the indication of the likelihood of the existence of the situation. For example, if the system 202 is configured to produce an image (or a sequence of images) of the traffic collision 134 and an existence of the traffic collision 134 is more likely at night than during the day, then the system 202 can be configured to operate at night, but not during the day. Alternatively or additionally, for example, if the system 202 is configured to produce an image (or a sequence of images) of the traffic collision 134, then the system 202 can be configured to receive, via the communications device 208, information that indicates that the traffic collision 134 is likely and the system 202 can be configured to produce, in response to a receipt of this information, the record of the traffic collision 134. For example, the microphone 154 included in the fourth node 144 can receive audio information that sounds like screeching tires and the fourth node 144 can communicate this audio information to one or more of the third node 142, the second node 140, or the fifth node 146, one or more of which, in response to a receipt of this audio information, can produce a corresponding image (or sequence of images) of the traffic collision 134.

Additionally, for example: (1) the instructions to perform the operations of the node in the blockchain can include instructions to produce a prospective block of the blockchain and (2) the instructions to communicate with the other node in the blockchain can include instructions to transmit, to the other node, the prospective block.

For example, the prospective block can include: (1) the record of the situation, (2) a hash of a previous block of the blockchain, and (3) a nonce. For example, in an implementation of the system 202 at the second node 140, the second node 140 can produce a prospective block of the blockchain that includes: (1) an image (or a sequence of images) of the traffic collision 134, (2) a hash of the previous block of the blockchain, and (3) a nonce. For example, in an implementation of the system 202 at the third node 142, the third node 142 can produce a prospective block of the blockchain that includes: (1) an image (or a sequence of images) of the traffic collision 134, (2) a hash of the previous block of the blockchain, and (3) a nonce. Additionally, the fifth node 146 can produce a prospective block of the blockchain that includes: (1) an image (or a sequence of images) of the traffic collision 134, (2) a hash of the previous block of the blockchain, and (3) a nonce.

Additionally, for example: (1) the electrical power source 206 of the system 202 can be configured to store a first amount of energy and (2) the other node can be configured to receive, as power for the other node, at least a second amount of energy. For example, the second amount of energy can be greater than the first amount of energy. For example, the other node can be disposed on a vehicle (e.g., the first vehicle 128), a roadside unit (e.g., the roadside unit 116) or a cloud computing platform (e.g., the cloud computing platform 136). For example, the other node can be a validator node while the node associated with the system 202 may not be a validator node. Having the node associated with the system 202 not be configured to be a validator node can reduce an amount of energy consumed by this node.

Additionally, for example: (1) the instructions to communicate with the other node in the blockchain can include instructions to receive, from the other node, a prospective block of the blockchain and (2) the instructions to perform the operations of the node in the blockchain can include instructions to perform a verification operation of the prospective block. For example, the prospective block can include: (1) another record of the situation, (2) a hash of a previous block of the blockchain, and (3) a nonce.

For example, in an implementation of the system 202 at the second node 140, the second node 140 can: (1) receive, from one or more of the third node 142 or the fifth node 146, a prospective block of the blockchain and (2) perform a verification operation of the prospective block. For example, in an implementation of the system 202 at the third node 142, the third node 142 can: (1) receive, from one or more of the second node 140 or the fifth node 146, a prospective block of the blockchain and (2) perform a verification operation of the prospective block. Additionally, the fifth node 146 can: (1) receive, from one or more of the second node 140 or the third node 142, a prospective block of the blockchain and (2) perform a verification operation of the prospective block.

Alternatively, the node can be a validator node. If the node is a validator node, then additionally, for example, the instructions to communicate with the other node in the blockchain can further include instructions to transmit, to the other node, a result of the verification operation. For example, the instructions to perform the operations of the node in the blockchain can further include: (1) instructions to perform the operations of a validator node in the blockchain, (2) instructions to participate, with other validator nodes of the blockchain, in a consensus operation of the blockchain, and (3) instructions to cause, in response to a result of the consensus operation being that the prospective block is valid, the prospective block to be added to a copy of the blockchain maintained by the node.

For example, in an implementation of the system 202 at the second node 140 in which the second node 140 is a validator node, the second node 140 can: (1) transmit, to one or more of the third node 142 or the fifth node 146, a result of the verification operation, (2) perform the operations of a validator node in the blockchain, (3) participate, with other validator nodes of the blockchain, in a consensus operation of the blockchain, and (4) cause, in response to a result of the consensus operation being that the prospective block is valid, the prospective block to be added to a copy of the blockchain maintained by the second node 140. For example, in an implementation of the system 202 at the third node 142 in which the third node 142 is a validator node, the third node 142 can: (1) transmit, to one or more of the second node 140 or the fifth node 146, a result of the verification operation, (2) perform the operations of a validator node in the blockchain, (3) participate, with other validator nodes of the blockchain, in a consensus operation of the blockchain, and (4) cause, in response to a result of the consensus operation being that the prospective block is valid, the prospective block to be added to a copy of the blockchain maintained by the third node 142. Additionally, if the fifth node 146 is a validator node, then the fifth node 146 can: (1) transmit, to one or more of the second node 140 or the third node 142, a result of the verification operation, (2) perform the operations of a validator node in the blockchain, (3) participate, with other validator nodes of the blockchain, in a consensus operation of the blockchain, and (4) cause, in response to a result of the consensus operation being that the prospective block is valid, the prospective block to be added to a copy of the blockchain maintained by the fifth node 146.

Additionally, for example, the memory 212 can further store a sensor verification module 224. For example, the sensor verification module 224 can include instructions that function to control the processor 210 to: (1) compare the record of the situation and the other record of the situation and (2) determine, in response to a result of a comparison of the record of the situation and the other record of the situation, a problem associated with the sensor 220. For example, the record of the situation can be an image (or a sequence of images) of the traffic collision 134.

For example, in an implementation of the system 202 at the second node 140, the second node 140 can: (1) compare an image (or a sequence of images) of the traffic collision 134 produced by the imaging sensor 150 and an image (or a sequence of images) of the traffic collision 134 produced by the imaging sensor 152 and an image (or a sequence of images) of the traffic collision 134 produced by the imaging sensor 156 and (2) determine, in response to a result of a comparison of the image (or the sequence of images) of the traffic collision 134 produced by the imaging sensor 150 and the image (or the sequence of images) of the traffic collision 134 produced by the imaging sensor 152 and the image (or the sequence of images) of the traffic collision 134 produced by the imaging sensor 156, a problem associated with the imaging sensor 150. For example, the problem associated with the imaging sensor 150 can be that a location of the second vehicle 130 at a time of the traffic collision 134 obstructed a line of sight between the imaging sensor 150 and the traffic collision 134. Alternatively or additionally, the problem associated with the imaging sensor 150 can be a malfunction in an operation of the imaging sensor 150.

For example, the situation, detected by the sensor 220 and for which a record is produced, can include a change with respect to an object in a vicinity of the sensor. Additionally, for example, the communications module 218 can further include instructions to communicate the change to another entity. For example, in an implementation of the system 202 at the third node 142: (1) the imaging sensor 152 can produce an image of the debris 118 that exists on the surface of the westbound lane 108 east of the road junction 106 and (2) the third node 142 can communicate information about the change to another entity. For example, the other entity can be the roadside unit 116, the cloud computing platform 136, or the like. For example, the other entity can be a traffic management system configured to transmit information that can affect traffic. For example, the other entity can be a map production system configured to incorporate information about a vicinity, including dynamic information, into a map of the vicinity. For example, the other entity can be a vehicle that operates using automated vehicle technology such that the information about the debris 118 that exists on the surface of the westbound lane 108 east of the road junction 106 can be used by the automated vehicle technology to change a trajectory of the vehicle.

For example, the situation, detected by the sensor 220 and for which a record is produced, can include a collision in a vicinity of the sensor 220 (e.g., the traffic collision 134). Additionally, for example, the memory 212 can further store a smart contract operation module 226. For example, the smart contract module 226 can include instructions that function to control the processor 210 to operate, in response to a production of the record of the situation, a smart contract associated with the situation. For example, the smart contract can be affiliated with one or more insurance companies of one or more of an operator of the second vehicle 130 or an operator of the third vehicle 132. For example, an operation of the smart contract, based on an image (or a sequence of images) of the traffic collision 134, can resolve legal liabilities, with respect to the traffic collision 134, between the operator of the second vehicle 130 and the operator of the third vehicle 132.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-3, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
an attachment mechanism configured to attach the system to a portable traffic marker;
an electrical power source configured to provide power to the system;
a communications device;
a processor; and
a memory storing:
a blockchain node module including instructions that, when executed by the processor, cause the processor to perform operations of a node in a blockchain; and
a communications module including instructions that, when executed by the processor, cause the processor to communicate, via the communications device, with another node in the blockchain.

2. The system of claim 1, wherein the portable traffic marker comprises at least one of a traffic cone, a construction barrel, a traffic barricade, a waffle-board barricade, a parade barricade, a Jersey barrier, a delineator, or a vertical traffic panel.

3. The system of claim 1, wherein the electrical power source comprises at least one of a battery, a fuel cell, a capacitor, a supercapacitor, or a solar panel.

4. The system of claim 1, wherein:
the blockchain is a permissioned blockchain,
the electrical power source is configured to store an amount of energy, and
a count of nodes included in the permissioned blockchain is a function of the amount of energy.

5. The system of claim 1, wherein the other node in the blockchain is a vehicle configured to operate as the other node in the blockchain.

6. The system of claim 1, further comprising a sensor.

7. The system of claim 6, wherein the sensor comprises at least one of an imaging sensor, a ranging sensor, or a microphone.

8. The system of claim 6, wherein the memory further stores a record production module including instructions that, when executed by the processor, cause the processor to produce a record of a situation detected by the sensor.

9. The system of claim 8, wherein the instructions to produce the record of the situation include instructions to produce, in response to a receipt of an indication of a likelihood of an existence of the situation, the record of the situation.

10. The system of claim 8, wherein:
the instructions to perform the operations of the node in the blockchain include instructions to produce a prospective block of the blockchain, the prospective block including:
the record of the situation,
a hash of a previous block of the blockchain, and
a nonce; and
the instructions to communicate with the other node in the blockchain include instructions to transmit, to the other node, the prospective block.

11. The system of claim 10, wherein:
the electrical power source of the system is configured to store a first amount of energy,
the other node is configured to receive, as power for the other node, at least a second amount of energy, and
the second amount of energy is greater than the first amount of energy.

12. The system of claim 8, wherein:
the instructions to communicate with the other node in the blockchain include instructions to receive, from the other node, a prospective block of the blockchain, the prospective block including:
another record of the situation,
a hash of a previous block of the blockchain, and
a nonce; and
the instructions to perform the operations of the node in the blockchain include instructions to perform a verification operation of the prospective block.

13. The system of claim 12, wherein:
the instructions to communicate with the other node in the blockchain further include instructions to transmit, to the other node, a result of the verification operation; and
the instructions to perform the operations of the node in the blockchain further include:
instructions to perform the operations of a validator node in the blockchain,
instructions to participate, with other validator nodes of the blockchain, in a consensus operation of the blockchain, and
instructions to cause, in response to a result of the consensus operation being that the prospective block is valid, the prospective block to be added to a copy of the blockchain maintained by the node.

14. The system of claim 12, wherein the memory further stores a sensor verification module including instructions that, when executed by the processor, cause the processor to:
compare the record of the situation and the other record of the situation; and
determine, in response to a result of a comparison of the record of the situation and the other record of the situation, a problem associated with the sensor.

15. The system of claim 8, wherein the situation comprises a change with respect to an object in a vicinity of the sensor.

16. The system of claim 15, wherein the communications module further includes instructions to communicate information about the change to another entity.

17. The system of claim 8, wherein the situation comprises a collision in a vicinity of the sensor.

18. The system of claim 8, wherein the memory further stores a smart contract operation module including instructions that, when executed by the processor, cause the processor to operate, in response to a production of the record of the situation, a smart contract associated with the situation.

19. A blockchain, comprising:
a first portable traffic marker having a first electrical power source, a first communications device, a first processor, and a first memory, and configured to perform operations of a first node in the blockchain; and
a second portable traffic marker having a second electrical power source, a second communications device, a second processor, and a second memory, and configured to perform operations of a second node in the blockchain.

20. A blockchain, comprising:
a portable traffic marker having a first electrical power source, a first communications device, a first processor, and a first memory, and configured to perform operations of a first node in the blockchain; and
a vehicle having a second electrical power source, a second communications device, a second processor, and a second memory, and configured to perform operations of a second node in the blockchain.
